(19) United States
(12) Patent Application Publication
(10) Pub. No.: US 2004/0221158 A1
(43) Pub. Date: Nov. 4, 2004

(54) DIGITAL SIGNATURE AND VERIFICATION SYSTEM FOR CONVERSATIONAL MESSAGES

(75) Inventors: Terry M. Olkin, Los Gatos, CA (US); Jahanshah Moreh, Los Angeles, CA (US); Jeffrey C. Olkin, Woodside, CA (US)

Correspondence Address: INTELLECTUAL PROPERTY LAW OFFICE, 1901 S. BASCOM AVENUE, SUITE 660, CAMPBELL, CA, 95008, US

(73) Assignee: SECURE DATA IN MOTION, INC., San Mateo, CA (US)

(21) Appl. No.: 10/249,717

(22) Filed: May 2, 2003

(51) Int. Cl. H04L 9/00

(52) U.S. Cl. 713/170

(57) ABSTRACT

A digital signature verification system wherein a signature system may sign a conversational message, as might be used in a chat, instant messaging or enterprise instant messaging dialog, and a verification system may then verify the signature. The signature system may include a signing entity and a vault, wherein the signing entity provides the message and credentials and the vault creates the signature based on a first hash of the message that is further encrypted with a signature key. The verification system may include a validating entity and a verifier, wherein the validating entity provides the message, the signature, and assertions to the verifier and the verifier then forms a second hash of the message, uses a verification key corresponding with the signature key to decrypt the signature and obtain the first hash, and compares the two hashes to determine a proper validation response.

### BACKGROUND OF INVENTION

1. Technical Field

The present invention relates generally to providing security for communications in computerized networks, and more particularly to efficiently maintaining security in chat and instant messaging systems. It is anticipated that one primary application of the present invention will be in enterprise instant messaging, both in local area networks and in wide are networks, including the Internet.

2. Background Art

Chat systems allow groups of people to carry out online conversations in real time. Two early such systems were UNIX talk and Internet Relay Chat (IRC). IRC enjoys considerable continued popularity, and provides a useful example here. Briefly, it consists of various separate networks or nets of IRC servers. Users run a client program to connect to an IRC server, and the IRC server then relays user's messages to and from the other IRC servers on the same net, and thus between the users. Once connected to an IRC server, a user usually enters a chat “room” or joins one or more “channels” to converse with others. These rooms and channels are typically devoted to different topics and chat conversations may be public, where everyone “present” can see the messages and participate in the conversation, or private, where people exchange messages and converse only with specific others.

The popularity of chat systems has motivated the development of a number of improvements, and particularly a new class of products known as instant messaging (IM) systems. IM systems allow their users to determine when specific other users are logged onto the network, and to send them private messages. Unlike chat systems, where conversations generally start out in a public room or channel and can then be “taken private,” IM conversations generally start out as and remain private. Also unlike most chat systems, which have only limited means to ensure that the participants are whom they represent themselves to be, the users of IM systems are registered in centralized databases that permit authentication of identity.

Chat and IM systems employ a dialog or conversational metaphor, but operate based on the exchange of messages. Many other messaging systems exist, of course, with the most common being e-mail. Such other systems, however, do not provide the interactive ability to converse with others in real time. To avoid confusion and distinguish from other messaging systems we will use the phrase “conversational messaging systems” to generically mean chat, IM, and the emerging variants of these.

Of special present interest is an emerging variant termed “Enterprise Instant Messaging” (EIM). Unlike prior conversational messaging systems, most enterprises using EIM systems regard it as desirable or even critical that their messages being conveyed be secured.

For purposes of this discussion, a secure conversation has six important attributes. First, every participant should preferably be authenticated. Second, every participant should preferably be authorized to engage in the conversation. Third, the confidentiality of all messages in the conversations should preferably be protected, both while in transit and in storage. Fourth, the integrity of all messages in the conversations should also preferably be protected both while in transit and in storage. Fifth, the messages in a conversation should preferably be digitally signable by any number of the participants, and those digital signatures should be verifiable at any time. And sixth, transcripts of the conversation should preferably be recordable with their security attributes intact (i.e., confidential and digitally signed). In particular, attributes five and six in this list have proven difficult to achieve.

A digital signature (hereafter simply called a signature) production and verification system is needed that permits a portion of the conversation to be signed by both the originator and the target. This implements the business semantics of an originator sending a non-repudiable message and the recipient acknowledging the receipt of that exact message.

Such a system should preferably also permit a signer to sign any portion of a conversation, and allow different portions of the conversation to be signed by different signers, both as either individual signers and as multiple signers. In the normal course of the conversation, not all exchanges need to have non-repudiation characteristics. However, messages that result in certain actions—for example a message to purchase stock at a certain amount—should be signable by the originator and be verifiable later.

In further keeping with the fifth attribute noted above, the desired system should also permit signature verification after a signature key has expired. This is particularly useful for situations when the validity of a conversation must be verified long after the system that issued the signature key ceases to exist.

The desired system should also be able to carry message signatures on to transcripts. That is, in the normal course of recording conversational messages, the system needs to delineate the portions of the conversations that are signed and to affix the signatures to those specific portions. In this manner, a transcript will have all the characteristics of the original conversation, including non-repudiation characteristics for messages that are explicitly signed. This is in keeping with the sixth attribute noted above.

A signature production and verification system should preferably be independent of the underlying digital signature technology. The only requirement should be that a signing party have a signature key and that a verifying party have a corresponding verification key. There should be no limitation that the signature and verification keys be different, the same, short-lived, long-lived, in a Public Key Infrastructure (PKI) certificate, and so forth.

Many widely used prior art security systems are based on PKI. These systems, however, have a number of disadvantages. For example, a signature production and verification system that uses PKI requires all signing participants to have long-lived, digital certificates whose key is suitable for producing digital signatures. The certificate of each signer must be available to all verifiers. Additionally, the revocation status of the signer's certificate must be known to all verifiers at the time of verification, which could be long after the certificate authority that issued the certificate has ceased its operation.

It is therefore further desirable to have a system that can use PKI certificates for signature production and verification, but not require it. That is, generally, any type of signature key should be usable, including a PKI verification key in a certificate, symmetric keys known to the signer and the verifier, and short-lived public keys in ephemeral assertions, whose corresponding private key is known to the signer.

Unlike a PKI system, a desirable signature production and verification system should also be able to record the validity status of a signer's key at the time of signature production. This should include recording the key, any certificates or assertions bearing the key, all certificates or assertions leading to the trust root, and the revocation status of each of the certificate (assertions are generally short-lived and never revoked).

### SUMMARY OF INVENTION

Accordingly, it is an object of the present invention to provide digital signature and verification system for conversational messages.

Briefly, one preferred embodiment of the present invention is a system for communicating a conversational message. The system calculates a first hash value based on the conversational message. The first hash value is then encrypted based on a signature key, to create a digital signature. The digital signature and the conversational message are communicated via a network. The digital signature is then decrypted based on a verification key, to reproduce the first hash value. A second hash value is calculated based on the conversational message. The first hash value is compared with the second hash value to determine a validation response, where the validation response indicates the conversational message is validated when the first and second hash values match.

Briefly, another preferred embodiment of the present invention is a system for creating a digital signature for a conversational message. The system calculates a hash value based on the conversational message. The hash value is then encrypted based on a signature key, to create the digital signature.

Briefly, yet another preferred embodiment of the present invention is a system for validating a digital signature for a conversational message. The system decrypts the digital signature based on a verification key, to reproduce a first hash value. A second hash is then calculates value based on the conversational message. The first hash value is then compared with the second hash value to determine a validation response, where the validation response indicates the conversational message to be validated when the first and second hash values match.

An advantage of the present invention is that it permits a portion of the conversation to be signed by both the originator and the target, to implement the business semantics of an originator sending a non-repudiable message and the recipient returning a non-repudiable acknowledgement about the receipt of that exact message.

Another advantage of the invention is that it permits signers to sign any portion of a conversation, and allow different portions to be signed by different signers, both as individual signers and as multiple signers.

Another advantage of the invention is that embodiments of it may provide any or all of the six important attributes of a secure conversation, wherein: every participant may be authenticated and authorized to engage in the conversation; the confidentiality and the integrity of all messages may be protected, both in transit and in storage; the messages may be digitally signable by any number of the participants, with those signatures verifiable at any time; and transcripts of the conversation may be recorded with their security attributes intact.

Another advantage of the invention is that, in further keeping with the noted attributes, some embodiments permit signature verification long after a signature key has expired and ceased to exist.

Another advantage of the invention is that, in further keeping with the noted attributes, some embodiments also permit carrying message signatures on to transcripts, with the ability to delineate the portions of the conversations that are signed and to affix the signatures to those specific portions.

Another advantage of the invention is that it is independent of the underlying digital signature technology used, with the only requirement being that a signing party have a signature key and that a verifying party have a corresponding verification key. There is no limitation that these keys be different, the same, short-lived, long-lived, or in a Public Key Infrastructure (PKI) certificate.

Another advantage of the invention is that, in further keeping with the preceding, is that it is not dependent on PKI, and thus does not require signing participants to have long-lived, digital certificates that are kept available with their revocation statuses for all potential, eventual verifiers.

And another advantage of the invention is that it is also able to determine what the validity status of a signer's key was at the time of signature production.

These and other objects and advantages of the present invention will become clear to those skilled in the art in view of the description of the best presently known mode of carrying out the invention and the industrial applicability of the preferred embodiment as described herein and as illustrated in the several figures of the drawings.

### BRIEF DESCRIPTION OF DRAWINGS

The purposes and advantages of the present invention will be apparent from the following detailed description in conjunction with the appended figures of drawings in which:

FIG. 1 is a schematic block diagram depicting a signature system according to the present invention.

FIG. 2 is a schematic block diagram depicting a verification system according to the present invention.

FIG. 3 is a flow chart depicting a process, whereby the signature system produces a signature and the verification system verifies that signature.

FIG. 4a-g are a collection of block diagrams depicting a number of possible arrangements of elements implementing embodiments of the invention, wherein FIG. 4b shows an embodiment in which a signing entity provides a message and signature to a validating entity, FIG. 4b shows a variation for providing the signature using an agent, FIG. 4c shows another variation for providing the signature using an agent, FIG. 4d shows a variation for validating the message and signature using an agent, FIG. 4e shows another variation for validating the message and signature using an agent, FIG. 4f shows yet another variation for validating the message and signature using an agent, and FIG. 4g shows still another variation for validating the message and signature using an agent.

FIG. 5 is a depiction of a EIM type conversational messaging dialog as an industrial sales example to show how the invention may be employed to sign and verify message units.

FIG. 6 is a schematic block diagram depicting the invention with a number of options.

And FIG. 7 is a schematic block diagram depicting the invention embodied to include a signature validation service.

In the various figures of the drawings, like references are used to denote like or similar elements or steps.

### DETAILED DESCRIPTION

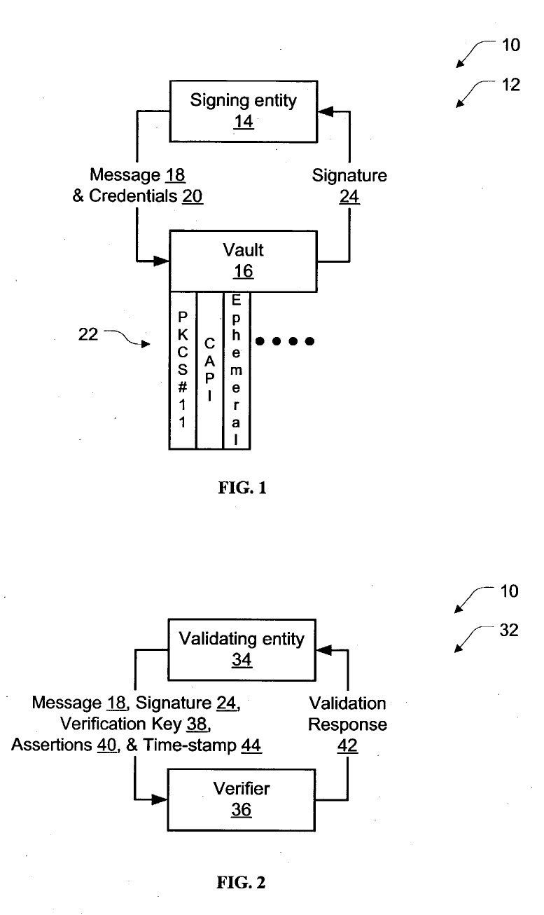

A preferred embodiment of the present invention is a digital signature and verification (DSV) system for conversational messaging. As illustrated in the various drawings herein, and particularly in the views of FIGS. 1, 2, and 6, preferred embodiments of the invention are depicted by the general reference character 10.

Throughout the following discussion of the DSV system 10 it should be kept in mind that this invention operates in the context of conversational messaging. That is, chat, instant messaging (IM), and enterprise instant messaging (EIM). Unlike other messaging schemes, such as e-mail, where an entire dialog, one side of a dialog, or critical sections of a dialog cannot be treated collectively for signature and verification purposes, the DSV system 10 is well suited for the dynamic, flexible needs of conversational messaging, and particularly for EIM, where the lack of adequate security mechanisms has until now presented a serious hindrance and barrier to adoption.

FIG. 1 is a schematic block diagram depicting a signature system 12 according to the present invention. The signature system 12 includes two major elements, a signing entity 14 and a vault 16. The signing entity 14 supplies a message 18 to be signed and private credentials 20. The vault 16 receives these and further, with a signature key 22 it contains, produces a signature 24 for the message 18 that is returned to the signing entity 14.

FIG. 2 is a schematic block diagram depicting a verification system 32 according to the present invention. The verification system 32 also includes two major elements, a validating entity 34 and a verifier 36. The validating entity 34 supplies the message 18, the signature 24 a verification key 38, and assertions 40. The verifier 36 receives these, and with them produces a validation response 42 for the message 18 that is returned to the validating entity 34.

Collectively, the signature system 12 and the verification system 32 form an embodiment of the DSV system 10 that may employ conventional, existing formula for producing and verifying the signatures 24. The DSV system 10 uses two (possibly identical, but typically different) cryptographic keys, the signature key 22 and the verification key 38. These are usually different and asymmetric (e.g., using the Digital Signature Algorithm), but could also be identical and symmetric (e.g., using a Hashed Message Authentication Code).

Conceptually, the component that produces the signature 24 is the vault 16. In the inventors” presently preferred embodiment the vault 16 stores the signature key 22 but never emits it. Depending on the design or configuration of the vault 16, the signature key 22 may be stored permanently or ephemerally. In practice, the vault 16 may store multiple signature keys 22 and use multiple encryption protocols. FIG. 1 further depicts this.

In order for the vault 16 to produce the signature 24, the signing entity 14 provides it with the message 18 to be signed. As is discussed in more detail, presently, a message 18 may include a number of message units that comprise all, select portions of, or merely a single portion of a dialog in a conversational messaging session. The signing entity 14 may also provide the vault 16 with the private credentials 20. These may be based on what one knows, what one has, or what one is. For example, a password is an instance of what one knows, a hardware security module is an instance of what one has, and a biometric reading is an instance of what one is. The private credentials 20 may be made optional, but it is expected that most embodiments of the DSV system 10 will require and employ them, since they add considerable security and trustworthiness. For cases where the vault 16 stores multiple signature keys 22, say, for one or more signing entities 14 using the same computer system, the signing entity 14 may also provide an indication of which signature key 22 to use. Alternately, the vault 26 can simply use the private credentials 20 to “open” and to choose an appropriate signature key 22. It then produces a signature 24 of the message 18 according to an appropriate algorithm.

Turning now particularly to FIG. 2, the major elements here are the validating entity 34 and the verifier 36. The validating entity 34 is a party seeking validation of the message 18. In many cases, the validating entity 34 will have directly received the message 18 from the signing entity 14, i.e., be the direct recipient, but this is not a requirement and a recipient can forward the message 18 to the validating entity 34 for verification.

Just as the verification system 32 is the counter part of the signature system 12, the verifier 36 is the counterpart of the vault 16. The validating entity 34 provides the verifier 36 with the message 18, the signature 24, the verification key 38, and the assertions 40. Unlike the vault 16, which stores the signature key 22, the verification key 38 in the embodiment in FIG. 2 is provided to the verifier 36 by the validating entity 34. This permits, for instance, the validating entity 34 to be a party other than the original recipient of the message. The verification key 38 should be valid at the time of verification specified by the validating entity 34 (e.g., not expired, revoked, impounded, enjoined, etc.). The assertions 40 along with an optional time-stamp 44 given to the verifier 36 by the validating entity 34 allow this. The assertions 40 allow the verifier 36 to confirm the verification key 38 and the right of the validating entity 34 to employ it for validation, as well as the right of the signing entity 14 for employing it for signing. The assertions 40 thus are analogous to public credentials. They provide “evidence” that the verification key corresponds to the signing key, in possession of the signer. The assertions 40 may also be optional in simpler, less secure embodiments of the inventive DSV system 10.

The time-stamp 44, just noted in passing, bears further consideration. It may be provided by the validating entity 34 to the verifier 36, and the verifier 36 can then use it to answer whether the signature key 22 was valid at the specific time in the time-stamp 44. Accordingly, the validating entity 34 can dynamically ask the question: “was this signature 24 valid at such and such time?” This particularly solves a serious problem of the prior art systems, wherein temporal validation is no longer possible when a key expires and is gone. The time-stamp 44 itself can come from the message 18, but it need not (e.g., if the document was allegedly signed at some time T, then the validating entity 34 can ask the verifier 36 the question: “was this signature valid at time T”). An advantage here is that the validating entity 34 need not depend upon the existence of a trusted time stamp service.

We next outline the general signature and verification processes. Briefly, we describe these below using the following legend:

M=Message to be signed and verified

S=Signature for a message

H=A one-way hash function; H1 and H2 are used here (e.g., Secure Hash Algorithm, a.k.a. SHA-1)

K1=Signature key

K2=Verification key

E=Encryption function

D=Decryption function

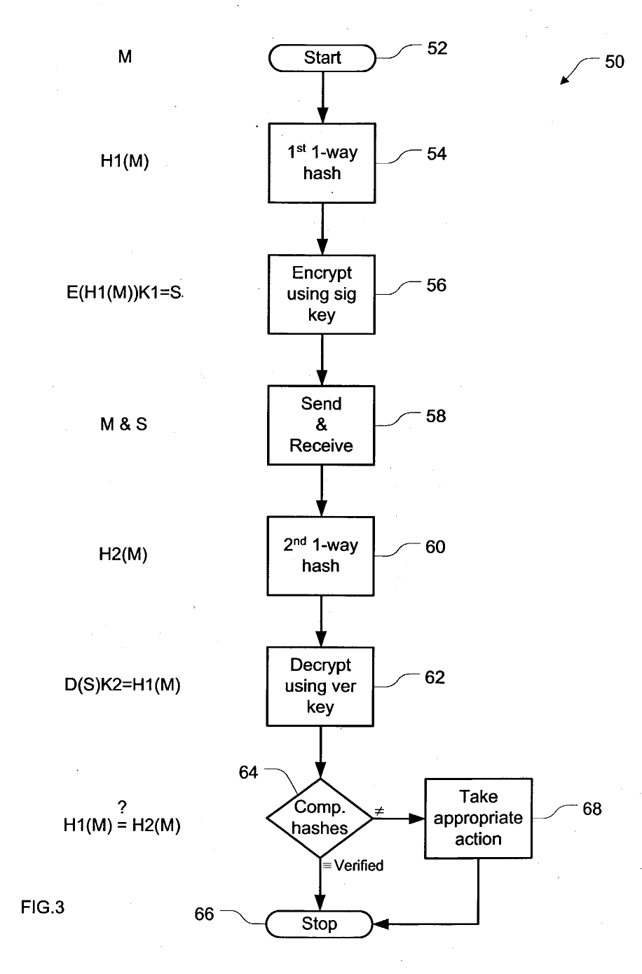

FIG. 3 is a flow chart depicting a process 50, whereby the signature system 12 produces the signature 24 and the verification system 32 verifies that signature 24. The process 50 starts with a step 52, where the signing entity 14 has composed or otherwise provided the message 18 to be signed. In a step 54, a first one-way hash, H1 (M), of the message 18 is produced. In a step 56, the first one-way hash is encrypted with the signature key 22 to produce the signature 24, E(H1(M))K1, or simply, S.

Steps 52-56 are performed by or under the control of the signature system 12. In a step 58, the message 18 and its signature 24 are communicated to the verification system 32, where the following additional steps are performed.

In a step 60, a second one-way hash is produced based on the received message 18, using a hash algorithm that produces the same result as the one used in step 54. The message 18 here is allegedly an exact copy of the message 18 that was signed. In a step 62, the received signature 24 is decrypted with the verification key 38 according to the formula D(S)K2, or D(E(H1(M))K1)K2, and should reproduce the first one-way hash.

In a step 64, the first one-way hash and the second one-way hash are compared. If they are the same, the signature 24 is considered to be verified. Alternately, if the hashes are not the same, the signature 24 is not verified. In a step 66, the process 50 ends, with appropriate action based upon the results of a failed verification in step 68, if necessary.

Generally, there are five conditions that can result in the signature 24 not being verified. First, the received message 18 can be altered. Second, the received signature 24 can be altered. Third, the verification key 38 can be wrong. i.e., incorrect for use with the signature key 22. Fourth, the one-way hash algorithms used in step 54 and step 60 can be incompatible, i.e., produce different results when used on the same message. And fifth, the encryption and decryption algorithms used may be incompatible.

The first and second of these cases are precisely those the process 50 is intended to detect, while the third, fourth and fifth cases will typically be due to simple user error that can be quickly remedied. For example, in embodiments where different hash or encryption algorithms are permitted, algorithm identifiers may be also be communicated in step 58.

With reference again to all of FIG. 1-3, it can be seen that the process 50 has not been described closely tied to either the signing entity 14 and vault 16 of the signature system 12 or the validating entity 34 and verifier 36 of the verification system 32. Carrying out the steps of the process 50 in the physical elements of the signature system 12 and the verification system 32 as described above is inventors' presently preferred embodiment, but the spirit of the invention encompasses more than merely this arrangement and other embodiments may equally or even more suitable in some applications.

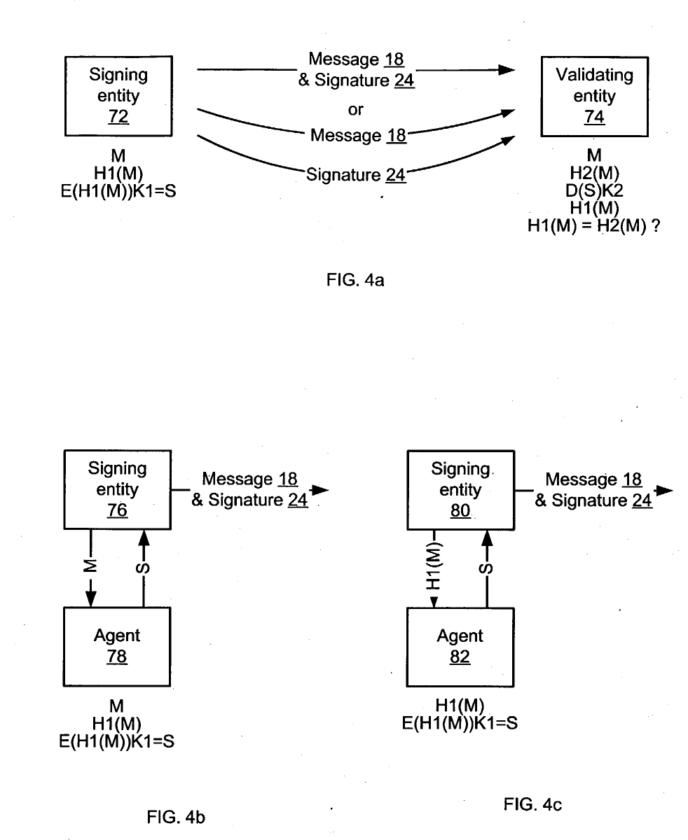

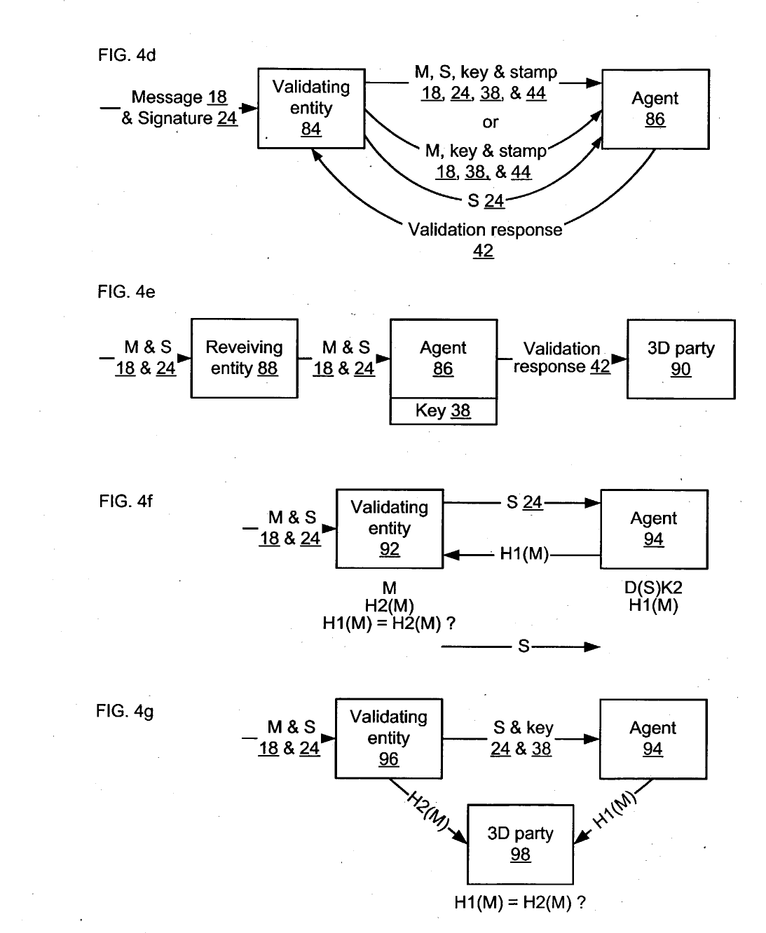

FIG. 4a-g are a collection of block diagrams depicting, without limitation, a number of possible arrangements of elements implementing the DSV system 10. FIG. 4b shows a basic embodiment in which a signing entity 72 provides the message 18 and the signature 24 to a validating entity 74. The signing entity 72 here performs the tasks that the signing entity 14 and vault 16 did in the signature system 12 of FIG. 1, and the validating entity 74 performs the tasks that the validating entity 34 and verifier 36 did in the verification system 32 of FIG. 2. It should be noted that the message 18 and the signature 24 can travel together or separately, with both of these variations depicted in FIG. 4a.

FIG. 4b shows a variation for providing the signature 24. Here the a signing entity 76 provides the message 18 to an agent 78. The agent 78 produces the first one-way hash, H1(M), of the message 18 and encrypts it with the signature key 22 to produce the signature 24, E(H1(M))K1, or S. Effectively the signing entity 76 here is analogous to the signing entity 14 and the agent 78 here is analogous to the vault 16 in FIG. 1. The signing entity 76 and the agent 78 may be within one computer. Or they may be in separate computers, say, on a local area network, typically behind a firewall. Or they can be widely separated, say, by a wide area network, and then with other security protections used as well. Furthermore, while FIG. 4b shows the signature 24 being returned to the signing entity 76 and the message 18 and the signature 24 being sent onward from there, it is also possible for the agent 78 to send these onward on behalf of the signing entity 76. In FIG. 4a-g major example variations are shown, but not minor ones that should be clear once the principles of the invention are grasped.

FIG. 4c shows another variation for providing the signature 24. Here the a signing entity 80 produces the first one-way hash, H1 (M), of the message 18 and sends it to an agent 82. That agent 82 then encrypts the first one-way hash with the signature key 22 to produce the signature 24, E(H1(M))K1, or S. Aspects to consider here are that the first one-way hash will typically be much smaller than the original message 18 and thus easier to communicate, and that the agent 82 here does not see the original message 18.

FIG. 4d shows a variation for validating the message 18 and the signature 24. Here a validating entity 84 receives the message 18 and the signature 24 and sends them both to an agent 86. Alternately, the validating entity 84 can receive the message 18 and send it to the agent 86, while the agent 86 receives the signature 24 via another route. The agent 86 then produces the second one-way hash, H2(M), of the message 18; decrypts the signature 24 according to the formula D(S)K2, or D(E(H1(M))K1)K2, to reproduce the first one-way hash, H1(M); compares the first one-way hash with the second one-way hash; and provides the validating entity 84 with the validation response 42. The agent 86 needs the verification key 38 for this, but it can be provided by the validating entity 84 (or be already held or otherwise obtained by the agent 86., see e.g., FIG. 4e) This variation may effectively be the same as the verification system 32 with the validating entity 34 and verifier 36 in FIG. 1.

FIG. 4e shows another variation for validating the message 18 and the signature 24. Here a receiving entity 88 (potentially any party receiving the message and signature and passing them onward) receives the message 18, and sends the message 18 and the signature 24 to the agent 86 (here the actual “validating” entity), which is potentially the same agent 86 used in FIG. 4d. Here the agent 86 does have the verification key 38 (or the receiving entity 88 can provide this also, see e.g., FIG. 4d). Unlike the case in FIG. 4d, however, the agent 86 here provides the validation response 42 to a third party 90. The third party 90 does not see the content of the message 18.

FIG. 4f shows yet another variation for validating the message 18 and the signature 24. Here a validating entity 92 receives the message 18 and the signature 24, but sends only the signature 24 to an agent 94 (and also the verification key 38, if the agent 94 does not have access to it otherwise). The agent 94 then decrypts the signature 24 according to the formula D(S)K2, or D(E(H1 (M)) K1)K2, to reproduce the first one-way hash, H1(M), and sends the first one-way hash back to the validating entity 92. The validating entity 92 produces the second one-way hash, H2(M), of the message 18 and compares it with the first one-way hash to ascertain whether the message 18 validates. The agent 94 does not see the content of the message 18, and the signature 24 and the second one-way hash communicated here will typically be small and thus easily manageable.

FIG. 4g shows still another variation, extending the variation in FIG. 4f somewhat. Here a validating entity 96 receives the message 18 and the signature 24, and sends just the signature 24 to an agent 94, which is potentially the same agent 94 used in FIG. 4f. The validating entity 96 also produces the second one-way hash, H2 (M), of the message 18, but here sends it to a third party 98. The agent 94 decrypts the signature 24 according to the formula D(S) K2, or D(E(H1(M))K1)K2, to reproduce the first one-way hash, H1 (M), but here sends that to the third party 98. The third party 98 is now able to compare the separately received first one-way hash with the second one-way hash to ascertain whether the message 18 validates. Neither the agent 94 or the third party 98 here sees the content of the message 18, and the elements communicated beyond the validating entity 96 typically will be small and easily manageable.

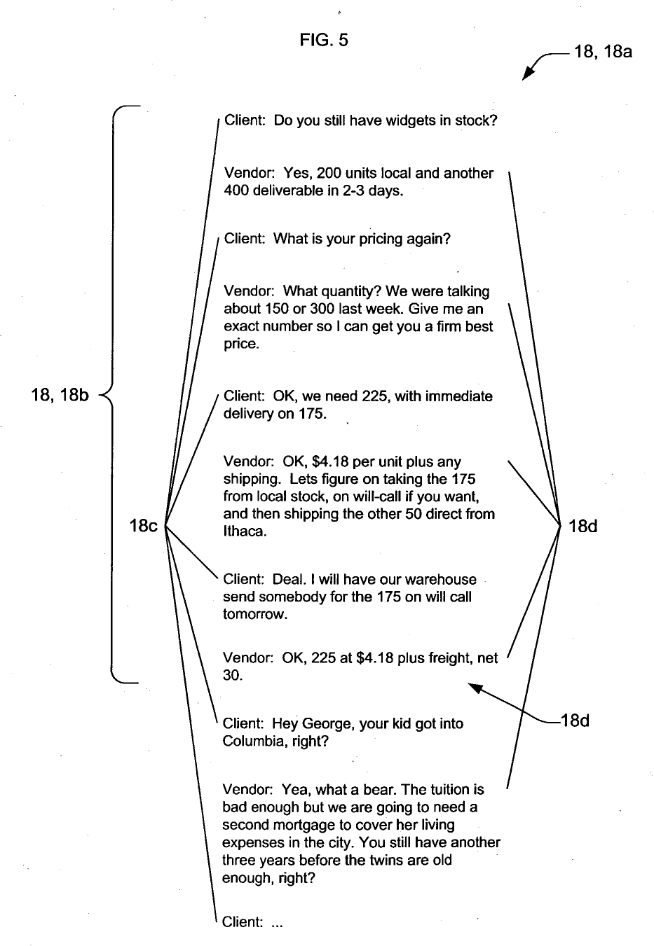

FIG. 5 is a depiction of a conversational messaging dialog, i.e., an EIM dialog, used in an industrial sales example to show how the inventive DSV system 10 may be employed to sign and verify message units. As previously noted a message 18 may include a number of message units that comprise all, select portions of, or merely a single portion of a dialog. Accordingly the message 18 for purposes of the signature 24 may be the entire dialog 18a in FIG. 5. Alternately, the message 18 may be the partial dialog 18b, excluding the chit chat after the details of the sales contract have been agreed to. Alternately, the message 18 can comprise only the client statements 18c, or only the vendor statements 18d, or the client statements 18c can comprise a first signed and verifiable message 18 and the vendor statements 18d can comprise a second signed and verifiable message 18. Still alternately, the message 18 can comprise only a single statement 18e. Those skilled in the present art will appreciate that, with the exception of the last case stated, messaging systems, such as e-mail, cannot be effectively secured in the manner described. The industrial sales example here is typical of how people usually communicate most efficiently, i.e., in interactive “real time” conversations. For transactions like this, and many others, EIM is preferable over systems that use protracted message exchanges, such as e-mail, voice mail, postal mail, telegraph, etc. The inventive DSV system 10 provides a way to secure conversational messaging (e.g., chat, IM, and EIM), dynamically and flexibly, as needs dictate and as the parties prefer.

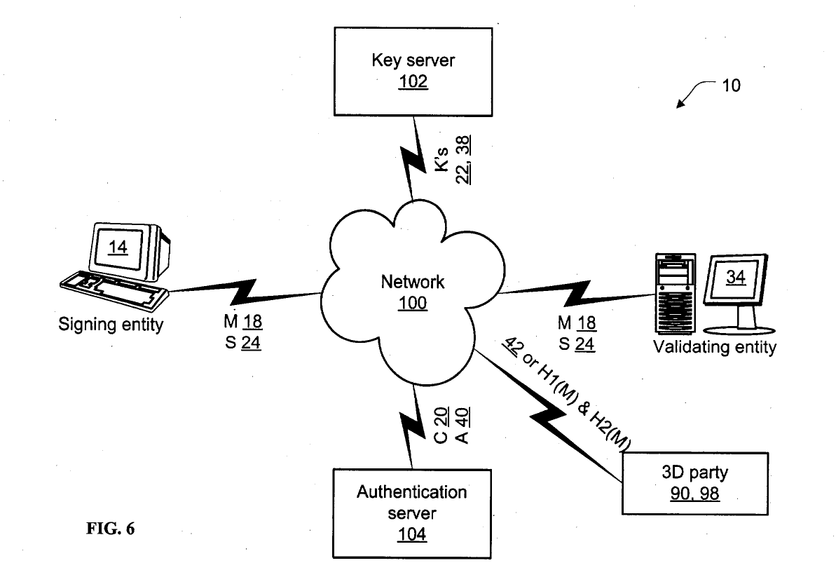

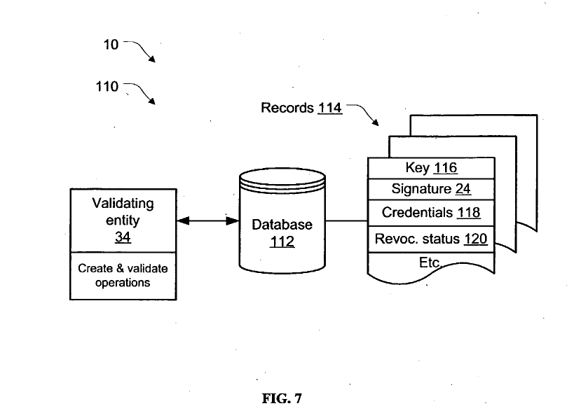

FIG. 6 is a schematic block diagram depicting the inventive DSV system 10 with a number of options. Here the signing entity 14 and the validating entity 34 again exchange a message 18, subject to validation with a signature 24. The message 18, the signature 24, and optionally other elements, described presently, are communicated via a network 100.

Optionally, a key server 102 may be provided and also accessible via the network 100. The key server 102 can provide or store either or both of the signature key 22 and the verification key 38. The spirit of the key server 102 is for storing keys that are used for protecting the confidentiality and integrity of the message 18. In most embodiments of the DSV system 10 that have the vault 16, it is private and thus will usually be preferable for storing the signature key 22. The verification key 38 may be stored in the key server 102, but it will more generally be carried in public credentials (e.g., assertions, certificates, etc.). Accordingly, the key server 102 is one possible option in the DSV system 10, albeit one that may not be used widely.

Also optionally, an authentication server 104 may be provided and be also accessible via the network 100. The authentication server 104 can issue or vouch for either or both of the private credentials 20 and the assertion 40. Both of these options may be desirable to organizations employing the DSV system 10, particularly for EIM purposes as already discussed.

If desired, the validation response 42 can be communicated to the third party 90 via the network 100, or the hash values, H1(M) and H2(M), can be communicated to the third party 98 via the network 100, to determine the validation response 42 there. These options further facilitate EIM.

The network 100 may be a local area type network or a wide area type network, such as the Internet. The signing entity 14, validating entity 34, key server 102, authentication server 104, and third party 90, 98 all are or include computerized systems. For example, without limitation, personal computers (PCs) and communication capable personal digital assistants (PDAs) are excellent candidates for the signing entity 14, validating entity 34, and third party 90, 98. Even sophisticated smart cards are suitable “computerized systems” for use as all or an element of the signing entity 14 and validating entity 34. Existing single and multiprocessor systems are excellent candidates for the key server 102 and authentication server 104.

Throughout this document we have often made the implicit assumption that the validating entity is one of the intended targets of the statements in a conversational messaging exchange. This need not always be the case. A signature validation service can be deployed to validate the signature of a message and then communicate the result of that to a requesting party (e.g., the third party 90, 98). This ability is particularly useful in situations where the recipient of a message does not have or does not want to have the resources to validate a specific signature. This is consistent with roles of the agents 86, 94, already discussed.

FIG. 7 is a schematic block diagram depicting the inventive DSV system 10 embodied to take this further, with a signature validation service 110. The signature validation service 110 can be particularly useful long after the life of a transaction. For example, in the case of litigation, a valid signature can be instrumental in tracing a transaction to its original signer.

Conceptually, long-lived validation is somewhat different from real-time verification. The difference is the amount that each relies on external data and services. While a real-time verification service can rely on other data or services (e.g., certificate resource list (CRL) in an lightweight directory access protocol (LDAP) directory or an on-line certificate status protocol (OCSP) server), a long-lived validation service should preferably be as self-sufficient as possible. That is, aside from the original message or set of messages whose signature it validates, it should preferably not rely on any other data or service. Accordingly, a long-lived validation service should support two operations: create and validate.

In the inventors' presently preferred embodiment of the signature validation service 110, the create operation populates a database 112 with a record 114 for each message 18 (i.e., each message 18 as defined and signed, whether a single statement or a set of statements collectively signed). A primary key 116 for the database 112 is used that is based on a cryptographic hash of the message 18 and each record 114 further contains the signature 24 of the message 18, as well as public credentials 118 (e.g., a certificate or an assertion) that bears the verification key 38 and link it to the signing entity 14 of the message 18, and a revocation status 120 for the public credentials 118.

The signature validation service 110 can receive information to create the record 114 directly from the signing entity 14 (i.e., as an added recipient) or it can receive this information indirectly from a prior recipient. Since the primary key 116 used is a hash of the message 18, the message 18 itself may not be sent to the signature validation service 110, reducing communications traffic and adding security. The public credentials 118 can accompany the message 18, i.e., be supplied by the signing entity 14 or the signature validation service 110 can obtain them elsewhere (e.g., from the authentication server 104 or a conventional certificate service). The public credentials 118 are “public” in that they leave control of the signing entity, but they otherwise can range from being openly public to not being known anywhere outside the context of the DSV system 10 (e.g., the public credentials 118 potentially can even be the same as the private credentials 20 used when creating the signature 24, although this has clear disadvantages).

The validate operation takes the primary key 116 (the cryptographic hash of the message 18) as an input and based on the contents of its database 112 provides information about the validation status of the messages 18. In the inventors” presently preferred embodiment, it provides a Boolean indicating if the signature 24 is valid and an indication who signed the message 18, as determined by the name in the public credential 118 (ephemeral assertion or PKI certificate) of the original signing entity 14. The validate operation also provides a bundle of information about the path leading from the public credential 118 of the signing entity 14 to the root of a trust path (a chain of credentials of increasing trustworthiness, i.e., what vouches for the public credential 118, what vouches for that, and what vouches for that, etc.), as well as revocation data that supports the validity of all these credentials (e.g., the absence of a certificate on a valid CRL).

As a provider of long-lived validation, the signature validation service 110, can particularly employ the time-stamp 44 (FIG. 2). As was noted above, answering the question: “was this signature 24 valid at such and such time?” when a key used for signing has expired is a problem that prior art systems cannot handle, but which the inventive DSV system 10 can.

While various embodiments have been described above, it should be understood that they have been presented by way of example only, and not limitation. Thus, the breadth and scope of the invention should not be limited by any of the above described exemplary embodiments, but should be defined only in accordance with the following claims and their equivalents.

### INDUSTRIAL APPLICABILITY

The present DSV system 10 is well suited for application in conversational messaging contexts such as chat and instant messaging (IM), and particularly in the emerging variants of these such as enterprise instant messaging (EIM).

As has been discussed herein, a secure conversation has a number of important attributes and the inventive DSV system 10 can provide any or all of these for conversational messages. Every participant in a conversational messaging dialog can be authenticated and authorized to engage in the conversation. This may include both the originators and the targets of conversational messages, wherein any portions of the conversation, and different portions of the conversation may be signed by different signers, both as individuals and as groups of signers. The confidentiality and the integrity of all conversational messages can be protected, both while in transit and in storage. The messages may be digitally signed with all of the digital signatures verifiable long after the signature keys have expired and ceased to exist. Transcripts of the conversational messages may also be recorded with their security attributes intact (i.e., confidential and digitally signed), with the portions of the conversations that are signed delineated and having the signatures affixed to those specific portions.

The inventive DSV system 10 is also independent of the underlying digital signature technology it may use. A signing party needs a signature key and a verifying party needs to have a corresponding verification key, but there is no limitation that these be different, the same, short-lived, or long-lived. And there particularly is no limitation that a Public Key Infrastructure (PKI) certificate be used. In this latter respect, the DSV system 10 does not suffer from the disadvantages of PKI schemes where all signing participants must have digital certificates that are currently available, are verifiable by a currently existing and valid certificate authority, and have a currently determinable revocation status if signatures are to remain verifiable. The DSV system 10 may use PKI certificates for signature production and verification, but it does not require this.

For the above, and other, reasons, it is expected that the DSV system 10 of the present invention will have widespread industrial applicability. Therefore, it is expected that the commercial utility of the present invention will be extensive and long lasting.

1. A method for communicating a conversational message, the method comprising the steps of:
in a first computerized system, calculating a first hash value based on the conversational message;
in a second computerized system, encrypting said first hash value based on a signature key, thereby creating a digital signature;
communicating said digital signature to a third computerized system and the conversational message to a fourth computerized system via a network;
in said third computerized system, decrypting the digital signature based on a verification key to reproduce said first hash value;
in said fourth computerized system, calculating a second hash value based on the conversational message;
in a fifth computerized system, comparing said first hash value with said second hash value to determine a validation response, wherein said validation response indicates the conversational message to be validated when said first hash value and said second hash value match; and
wherein both or neither of said first and said second computerized systems may be the same and all, some, or none of said third, said fourth, and said fifth computerized systems may be the same.

2. A method for creating a digital signature for a conversational message, the method comprising the steps of:
in a first computerized system, calculating a hash value based on the conversational message;
in a second computerized system, encrypting said hash value based on a signature key, thereby creating the digital signature; and
wherein both or neither of said first and said second computerized systems may be the same.

3. The method of claim 2, wherein the conversational message is signed by a signing entity, and the method further comprising the step of authenticating said signing entity.

4. The method of claim 3, wherein said step of authenticating includes validating a private credential of said signing entity.

5. The method of claim 3, further comprising the step of procuring said signature key from a server that is physically separate from said signing entity.

6. The method of claim 3, further comprising the step of generating said signature key.

7. The method of claim 2, wherein said signature key is not from an X.509 certificate issued in a PKI environment.

8. The method of claim 2, wherein at least said step of encrypting is performed in a vault.

9. The method of claim 8, wherein said vault procures said signature key from a server that is physically separate from said vault.

10. The method of claim 8, wherein:
the conversational message unit is signed by a signing entity, and
said vault authenticates said signing entity prior to performing said step of encrypting.

11. The method of claim 8, wherein said vault is physically separate from said signing entity and said signing entity and said vault communicate via a network.

12. The method of claim 2, wherein:
the conversational message includes a plurality of conversational message units; and
said step of calculating and said step of encrypting are performed on said plurality of conversational message units collectively.

13. The method of claim 12, further comprising selecting said plurality of conversational message units from among conversational message elements in a dialog.

14. The method of claim 13, further comprising the step of storing a transcript, wherein said transcript includes said conversational message elements.

15. A method for validating a digital signature for a conversational message, the method comprising the steps of:
in a first computerized system, decrypting the digital signature based on a verification key to reproduce a first hash value;
in a second computerized system, calculating a second hash value based on the conversational message;
in a third computerized system, comparing said first hash value with said second hash value to determine a validation response, wherein said validation response indicates the conversational message to be validated when said first hash value and said second hash value match; and
wherein all, some, or none of said first, said second, and said third computerized systems may be the same.

16. The method of claim 15, wherein the conversational message is validated by a validating entity, and the method further comprising the step of authenticating said validating entity.

17. The method of claim 16, wherein said step of authenticating includes validating an assertion of said validating entity.

18. The method of claim 17, further comprising the step of soliciting said assertion from a server that is physically separate from said validating entity.

19. The method of claim 16, further comprising the step of procuring said verification key from a server that is physically separate from said validating entity.

20. The method of claim 15, wherein said validation key is not from an X.509 certificate issued in a PKI environment.

21. The method of claim 15, wherein at least said step of decrypting is performed in a verifier.

22. The method of claim 21, wherein said verifier procures said verification key from a server that is physically separate from said verifier.

23. The method of claim 21, wherein:
the digital signature is validated by a validating entity, and
said verifier authenticates said validating entity prior to performing said step of decrypting.

24. The method of claim 23, wherein said verifier is physically separate from said validating entity and said validating entity and said verifier communicate via a network.

25. The method of claim 15, further comprising the step of communicating said validation response to a third party.

26. The method of claim 15, further comprising the step of communicating said first hash value and said second hash value to a third party.

27. The method of claim 15, wherein the conversational message includes at least one conversational message element in a dialog, and the method further comprising the step of storing a transcript, wherein said transcript includes the conversational message elements.

28. A computer program, embodied on a computer readable storage medium, for creating a digital signature for a conversational message, comprising:
a code segment that calculates a hash value based on the conversational message; and
a code segment that encrypts said hash value based on a signature key, thereby creating the digital signature; and
wherein both or neither of said code segment that calculates and said code segment that encrypts run in same computerized systems.

29. The computer program of claim 28, wherein the conversational message is signed by a signing entity, and further comprising a code segment that authenticates said signing entity.

30. The computer program of claim 29, wherein said code segment that authenticates also validates a private credential of said signing entity.

31. The computer program of claim 29, further comprising a code segment that procures said signature key from a server that is physically separate from said signing entity.

32. The computer program of claim 28, further comprising a code segment that generates said signature key.

33. The computer program of claim 28, further comprising a code segment that provides a vault, wherein at least said code segment that encrypts operates in said vault.

34. The computer program of claim 33, wherein said vault procures said signature key from a server that is physically separate from said vault.

35. The computer program of claim 33, wherein:
the conversational message unit is signed by a signing entity, and
said vault authenticates said signing entity prior to said code segment that encrypts encrypting.

36. The computer program of claim 34, wherein said vault is physically separate from said signing entity and said signing entity and said vault communicate via a network.

37. The computer program of claim 28, further comprising:
a code segment that defines the conversational message to include a plurality of conversational message units; and wherein
said code segment that calculates and said code segment that encrypts operate on said plurality of conversational message units collectively.

38. The computer program of claim 37, wherein said code segment that defines the conversational message selects said plurality of conversational message units from among conversational message elements in a dialog.

39. The computer program of claim 38, further comprising a code segment that stores a transcript, wherein said transcript includes said conversational message elements.

40. A computer program for validating a digital signature for a conversational message, comprising:
a code segment that decrypts the digital signature based on a verification key to reproduce a first hash value;
a code segment that calculates a second hash value based on the conversational message;
a code segment that compares said first hash value with said second hash value to determine a validation response,
wherein said validation response indicates the conversational message to be validated when said first hash value and said second hash value match; and
wherein all, some, or none of said code segment that decrypts, said code segment that calculates, and said code segment that compares run in same computerized systems.

41. The computer program of claim 40, wherein the conversational message is validated by a validating entity, and the method further comprising a code segment that authenticates said validating entity.

42. The computer program of claim 41, wherein said code segment that authenticates validates an assertion of said validating entity.

43. The computer program of claim 42, further comprising a code segment that solicits said assertion from a server that is physically separate from said validating entity.

44. The computer program of claim 41, further comprising a code segment that procures said verification key from a server that is physically separate from said validating entity.

45. The computer program of claim 40, further comprising a code segment that provides a verifier, wherein at least said code segment that decrypts operates in said verifier.

46. The computer program of claim 45, wherein said verifier procures said verification key from a server that is physically separate from said verifier.

47. The computer program of claim 45, wherein:
the digital signature is validated by a validating entity, and said verifier authenticates said validating entity prior to operation of said code segment that decrypts decrypting.

48. The computer program of claim 47, wherein said verifier is physically separate from said validating entity and said validating entity and said verifier communicate via a network.

49. The computer program of claim 40, further comprising a code segment that communicates said validation response to a third party.

50. The computer program of claim 40, further comprising a code segment that communicates said first hash value and said second hash value to a third party.

51. The computer program of claim 40, wherein the conversational message includes at least one conversational message element in a dialog, and further comprising a code segment that stores a transcript, wherein said transcript includes the conversational message elements.

52. An apparatus for creating a digital signature for a conversational message, comprising:
a first computerized system having logic able to calculate a hash value based on the conversational message;
a second computerized system having logic able to encrypt said hash value based on a signature key, thereby creating the digital signature; and
wherein both or neither of said first and said second computerized systems may be the same.

53. The apparatus of claim 52, wherein the conversational message is signed by a signing entity, and said second computerized system further includes logic able to authenticate said signing entity with a server via a network.

54. The apparatus of claim 52, wherein said logic able to authenticate also validates a private credential of said signing entity.

55. The apparatus of claim 52, wherein said second computerized system further includes logic able to procure said signature key from a server via a network.

56. The apparatus of claim 52, wherein said second computerized system further includes logic able to generate said signature key.

57. The apparatus of claim 52, wherein said second computerized system encrypts said hash value in a vault.

58. The apparatus of claim 52, wherein said vault procures said signature key from a server that is physically separate from said vault.

59. The apparatus of claim 58, wherein:
the conversational message unit is signed by a signing entity, and
said second computerized system further includes logic able to authenticate said signing entity for said vault with a server via a network.

60. The apparatus of claim 57, wherein said second computerized system further includes logic able to procure said signature key for said vault from a server via a network.

61. The apparatus of claim 52, wherein said first computerized system further includes logic able to construct the conversational message to include a plurality of conversational message units.

62. The apparatus of claim 61, wherein said first computerized system further includes logic able to select said plurality of conversational message units from among conversational message elements in a dialog.

63. The apparatus of claim 62, wherein said first computerized system further includes logic able to store a transcript, wherein said transcript includes said conversational message elements.

64. An apparatus for validating a digital signature for a conversational message, comprising:
a first computerized system having logic able to decrypt the digital signature based on a verification key to reproduce a first hash value;
a second computerized system having logic able to calculate a second hash value based on the conversational message;
a third computerized system having logic able to compare said first hash value with said second hash value to determine a validation response, wherein said validation response indicates the conversational message to be validated when said first hash value and said second hash value match; and
wherein all, some, or none of said first, said second, and said third computerized systems may be the same.

65. The apparatus of claim 64, wherein said first computerized system further includes logic able to authenticate said validating entity with a server via a network.

66. The apparatus of claim 64, wherein said first computerized system further includes logic able to procure said verification key from a server via a network.

67. The apparatus of claim 64, wherein said first computerized system decrypts the digital signature in a verifier.

68. The apparatus of claim 67, wherein said first computerized system further includes logic able to procure said verification key for said verifier from a server via a network.

69. The apparatus of claim 67, wherein:
the digital signature is validated by a validating entity, and
said first computerized system further includes logic able to authenticate said validating entity for said verifier with a server via a network.

70. The apparatus of claim 64, wherein said third computerized system further includes logic able to communicate said validation response to a third party via a network.

71. The apparatus of claim 64, wherein the conversational message includes at least one conversational message element in a dialog, and one of said first computerized system, said second computerized system, and said third computerized system further includes logic able to store a transcript, wherein said transcript includes the conversational message elements.

72. The apparatus of claim 64, wherein:
said third computerized system is not also said first computerized system or said second computerized system;
said first computerized system further includes logic able to communicate said first hash value to said third computerized system via a network; and
said second computerized system further includes logic able to communicate said second hash value to said third computerized system via said network.

73. An apparatus for creating a digital signature for a conversational message, comprising:
means for calculating a hash value based on the conversational message;
means for encrypting said hash value based on a signature key, thereby creating the digital signature; and
wherein both or neither of said means for calculating and said means for encrypting may be same computerized systems.

74. An apparatus for validating a digital signature for a conversational message, comprising:
means for decrypting the digital signature based on a verification key to reproduce a first hash value;
means for calculating a second hash value based on the conversational message;
means for comparing said first hash value with said second hash value to determine a validation response, wherein said validation response indicates the conversational message to be validated when said first hash value and said second hash value match; and
wherein all, some, or none of said means for decrypting, said means for calculating, and said means for comparing may be same computerized systems.
